(19) United States
(12) Patent Application Publication
(10) Pub. No.: US 2007/0219291 A1
(43) Pub. Date: Sep. 20, 2007

(54) Inkjet ink, and inkjet ink set, inkjet ink tank, inkjet-recording method and inkjet-recording apparatus using the same

(75) Inventors: Takatsugu Doi, Kanagawa (JP); Ken Hashimoto, Kanagawa (JP)

Correspondence Address: FILDES & OUTLAND, P.C., 20916 MACK AVENUE, SUITE 2, GROSSE POINTE WOODS, MI, 48236, US

(73) Assignee: Fuji Xerox Co., Ltd.

(21) Appl. No.: 11/504,351

(22) Filed: Aug. 15, 2006

(30) Foreign Application Priority Data
Mar. 20, 2006 (JP) 2006-077066

(51) Int. Cl. C09D 11/02; C09D 11/00; C09D 5/00

(52) U.S. Cl. 523/160; 106/31.65; 106/31.86; 106/31.68; 523/161

(57) ABSTRACT

An inkjet ink includes at least colorant particles, a water-soluble organic solvent, and water, wherein each of the colorant particles has a core particle and a coating layer formed around it or adsorbed particles on the surface thereof and the core particle contains a resin material having a glass transition temperature (Tg) of 75° C. or lower.

### BACKGROUND

1. Technical Field

The present invention relates to an inkjet ink, and an inkjet ink set, an inkjet ink tank, an inkjet-recording method and an inkjet-recording apparatus using the same.

2. Related Art

Inkjet processes of ejecting ink from an ink-ejecting unit such as nozzle, slit, or porous film have been used in many printers, because they demand smaller space and are cheaper. Among many inkjet processes, a piezo ink-jet process of ejecting ink by using deformation of a piezoelectric device and a thermal ink-jet process of ejecting ink by using the boiling phenomenon of ink under application of heat energy are characteristically superior in image definition and printing speed.

Two of the current basic issues for inkjet printers are said to be increases in printing and in image quality. For example, the fixing property should be improved.

Addition of a resin (polymeric compound) to ink was proposed for improvement in the fixing property.

However, addition of a resin (polymeric compound) having a low glass transition temperature (Tg) to ink often causes, for example, a problem of the deterioration in storage stability due to self fusion of the resin (polymeric compound) in the ink.

### SUMMARY

According to an aspect of the present invention, there is provided an inkjet ink, comprising at least colorant particles, a water-soluble organic solvent, and water, each of the colorant particles comprising a core particle and a coating layer formed around the core particle and the core particle containing a resin material having a glass transition temperature (Tg) of 75° C. or lower.

### BRIEF DESCRIPTION OF THE DRAWINGS

Embodiments of the present invention will be described in detail, based on the following figures, wherein:

FIG. 1 is a perspective view illustrating the configuration of an exemplary embodiment of the inkjet-recording apparatus of the invention;

FIG. 2 is a perspective view illustrating the basic configuration inside the inkjet-recording apparatus shown in FIG. 1;

FIG. 3 is a perspective view illustrating the configuration of another exemplary embodiment of the inkjet-recording apparatus of the invention;

FIG. 4 is a perspective view illustrating the basic configuration inside the inkjet-recording apparatus shown in FIG. 3;

FIG. 5 is a perspective view illustrating the configuration of yet another exemplary embodiment of the inkjet-recording apparatus of the invention;

FIG. 6 is a schematic sectional view showing an example of a colorant particle, and

FIG. 7 is a schematic perspective view showing another example of a colorant particle.

### DETAILED DESCRIPTION

Hereinafter, the present invention will be described in detail.

### (Ink and Ink Set)

The inkjet ink of the invention contains at least colorant particles, a water-soluble organic solvent, and water. Each colorant particle has a core particle and a coating layer formed on the surface thereof or adsorbed particles on the surface thereof, and the core particle contains a resin material having a glass transition temperature (Tg) of 75° C. or lower.

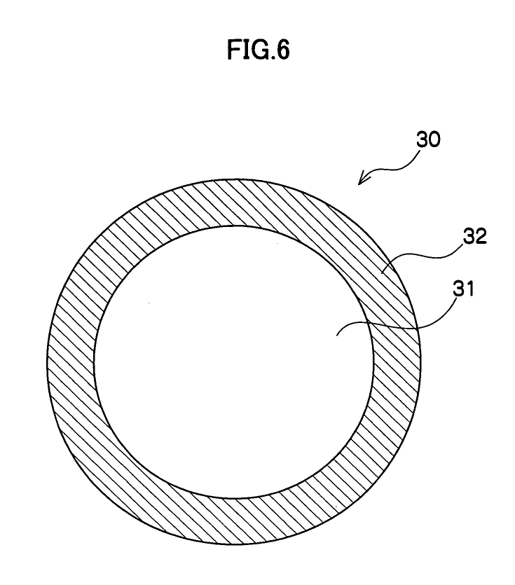

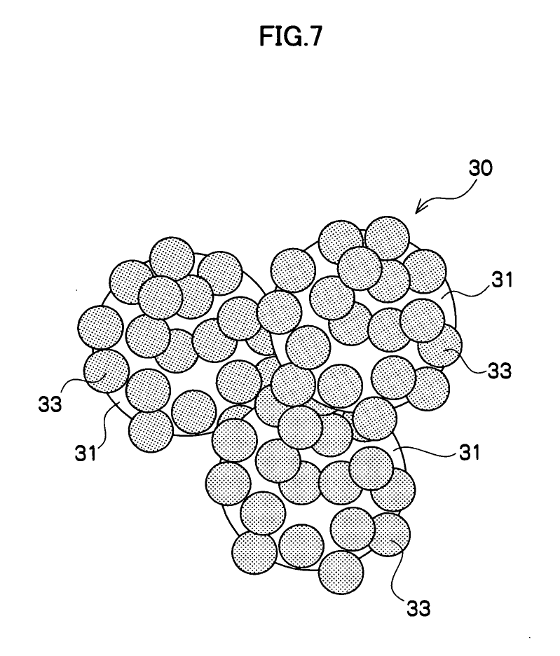

Specifically as shown in FIG. 6, the colorant particle 30 has a coating layer 32 formed around a core particle 31. As shown in FIG. 7, the colorant particle 30 may have adsorbed particles 33 around the core particle 31, i.e., adsorbed particles 33 on the surface of the core particle 31.

The inkjet ink of the invention is favorably used in combination with a processing solution at least containing a compound having an action to aggregate or insolubilize the ink components, a water-soluble solvent, and water (inkjet ink set of the invention).

The inkjet ink of the invention contains colorant particles in the so-called core/shell structure (core region corresponding to the core particle and shell region to coating layer or adsorbed particles), and the core particle in the core region contains a resin material having a specified glass transition temperature (Tg) for improvement in fixing property; and the core particle is covered with a coating layer or with adsorbed particles. For that reason, the coating layer, or the adsorbed particles, makes direct contact among the core particles containing the resin material more difficult even when colorant particles become in contact with each other, for example during storage at high temperature, preventing self fusion of the colorant particles in ink and thus, improving both fixing property and long-term storage stability.

It is also possible to improve the color formation property of the inkjet ink of the invention. It seems that the core particles, which are substantially colorless, prevent excessive absorption of light.

In addition, even when the inkjet ink of the invention is used in a thermal inkjet-recording apparatus and when the core particles are almost melted by the heat during ejection, the coating layer or adsorbed particle prevents direct contact between the core particles containing the resin material and thus, problems in ejection efficiency such as nozzle clogging.

Alternatively when the inkjet ink of the invention containing the colored particles is used in combination with a processing solution described below, it is possible to improve optical density, ink-bleeding resistance, intercolor bleeding resistance, and drying period by ejecting the ink and the processing solution in contact with each other on a recording medium. Although the mechanism is not clearly understood, contact between the ink and the processing solution on recording medium leads, for example, to aggregation of the colored particles and at the same time to separation of the colored particle aggregate from the solvent. When the colored particle aggregate is sufficiently larger than the opening between the fibers in the recording medium, it is seemingly possible to retain the colored particles on the recording medium surface at high density and raise its optical density. It is also possible to prevent spreading of the colored particle aggregate in the paper-surface direction and thus, to prevent ink bleeding and intercolor bleeding. It is also possible to shorten the drying period, by separating the colored particle aggregate form the solvent and allowing only the solvent to penetrate into the recording medium.

Use of a pigment or dye as the colorant as before occasionally resulted in deterioration in color formation property and irregularity in the solid image region. The deterioration in color formation property seems to be the result of the fact that the thickness of the aggregate layer of pigment or dye aggregate is significantly larger than the wavelength of visible light, allowing the light to be absorbed by the colorant aggregate. On the other hand, the irregularity in the solid image region seems to be due to the localization of the regions where the optical density is lower and higher due to variation in the distribution of colorant aggregates on the recording medium.

For that reason, it is possible to solve the problems, in specified such as deterioration in color formation property and irregularity in the solid image region, by using colored particles in the core/shell structure containing a colorless component (resin material) in the core region (core particle) and a colored component in the shell region (coating layer, adsorbed particle) as the colored particles. The mechanism, although not clearly understood, seems to be the followings:

As described above, it is necessary to make the particle diameter of the aggregate significantly larger than the width of the opening between fibers in the recording medium for improvement in optical density and ink-bleeding resistance in two-liquid reaction system. It is possible to prevent excessive light absorption by the colored particle aggregate and deterioration in color formation property, using colored particles having a colorless component in the core region as the colored particles. Similarly, even if the colored particles are unevenly distributed on the recording medium, it is possible to reduce the difference in light absorption due to uneven distribution of the colored particles and, as a result, to reduce the irregularity in the solid image region due to uneven distribution of the colored particles, by preventing excessive light absorption.

Thus, for more effective prevention of the deterioration in color formation property and the irregularity in the solid image region, the thickness of the colored particle layer of the colored particle aggregate is important, and the thickness of the shell region, the ratio in thickness between the core and shell regions, and the weight ratio of the core and shell regions in the colored particles are also important factors.

Hereinafter, the ink will be described.

The colorant particles will be described first. The colorant particle has a coating layer or adsorbed particles on the surface of the core particle. The colorant particles may be, for example, colored particles for image forming, or transparent particles for surface coating. The colorant particles, either colored or transparent, are prepared, according to the desirable material for use (whether colored or not). It is also possible, for example, to prepare colored particles by forming a thick coating layer or adhering adsorbed particle at a high coverage rate and transparent particles by forming a thin coating layer or adhering adsorbed particle at a low coverage rate.

The core particle contains, as described above, a resin material having a glass transition temperature (Tg) of 75° C. or lower. The glass transition temperature (Tg) is preferably 20° C. to 60° C. and more preferably, 40° C. to 60° C. An excessively high glass transition temperature (Tg) occasionally resulted in insufficient fixing property. Alternatively, an excessively low glass transition temperature (Tg) may lead to aggregation of the colorant particles by self fusion, for example, during storage at high temperature. In addition, when prints carrying a printed image are stored while the printed faces are in contact with each other, the printing faces may adhere to each other.

The resin material is not specifically limited, if it has a glass transition temperature (Tg) in the range above, and examples thereof include poly(meth)acrylic acid, poly(meth)acrylate, polymethyl methacrylate, polyethylene glycol, polypropylene glycol, polyester, polystyrene, polyethylene, polypropylene, polybutene, polyvinylalcohol, polyvinylpyrrolidone, styrene-(meth)acrylate copolymers, latexes, plastic pigments, microcrystalline waxes, silicones, fatty acid amides, vegetable waxes, animal waxes, synthetic hydrocarbon waxes, mineral waxes, petroleum waxes, synthetic waxes, and the like.

The weight-average molecular weight of the resin material is preferably 10,000 or more, more preferably 15,000 to 150,000, and still more preferably 30,000 to 100,000. A resin material having a weight-average molecular weight in the range above seemingly leads to improvement in the adhesiveness between the colorant and the recording medium and thus in fixing property.

The weight-average molecular weight is determined under the following condition: The GPC used was “HLC-8120GPC, SC-8020 (manufactured by Toso Corporation); the columns, TSK gel and Super HM-H (manufactured by Toso Corporation, 6.0 mm ID×15 cm); and the eluant, THF(tetrahydrofuran). The sample concentration in the test was 0.5 mass %; the flow rate, 0.6 ml/min; the sample injection, 10 μl, the measurement temperature, 40° C.; and the detector, an IR detector. A calibration curve is prepared by using 10 polystyrene standard samples: “TSK Standards” manufactured by Tosoh Corp.: “A-500”, “F-1”, “F-10”, “F-80”, “F-380”, “A-2500”, “F-4”, “F-40” “F-128”, and “F-700”.

The number-average particle diameter of the core particles is preferably 10 to 1,000 nm, more preferably 20 to 500 nm, and still more preferably 30 to 200 nm. Core particles having a number-average particle diameter in the range above satisfy the requirements in its dispersion stability and the color formation property of the printed image at the same time.

The coating layer or the adsorbed particle contains a colorant as its constituent material. The colorant may be a dye or pigment, but is preferably a pigment. It is because use of a pigment as the constituent material for the coating layer or the adsorbed particle improves optical density and light stability.

The pigment may be organic or inorganic, and examples of black pigments include carbon black pigments such as furnace black, lamp black, acetylene black, and channel black; and the like. In addition to black pigment and color pigments in three primary colors, cyan, magenta, and yellow, pigments in a specified color such as red, green, blue, brown, or white and pigments having metallic glossiness, for example in the color of gold or silver, may also be used. Inorganic oxides (such as silica, alumina, titanium oxide, and tin oxide) may also be used. In addition, the pigment may be a pigment newly prepared for the invention.

Typical examples of the pigments include, but are not limited to, Raven 7000, Raven 5750, Raven 5250, Raven 5000 ULTRAII, Raven 3500, Raven 2000, Raven 1500, Raven 1250, Raven 1200, Raven 1190 ULTRAII, Raven 1170, Raven 1255, Raven 1080, and Raven 1060 (manufactured by Columbian Chemicals Company); Regal 400R, Regal 330R, Regal 660R, Mogul L, Black Pearls L, Monarch 700, Monarch 800, Monarch 880, Monarch 900, Monarch 1000, Monarch 1100, Monarch 1300, and Monarch 1400 (manufactured by Cabot); Color Black FW1, Color Black FW2, Color Black FW2V, Color Black 18, Color Black FW200, Color Black S150, Color Black S160, Color Black S170, Printex 35, Printex U, Printex V, Printex 140U, Printex 140V; Special Black 6, Special Black 5, Special Black 4A, and Special Black 4 (manufactured by Degussa); No. 25, No. 33, No. 40, No. 47, No. 52, No. 900, No. 2300, MCF-88, MA600, MA7, MA8, and MA100 (manufactured by Mitsubishi Chemical Corp.); and the like.

Examples of cyan pigments include, but are not limited to, C.I. Pigment Blue-1, -2, -3, -15, -15:1, -15:2, -15:3, -15:4, -16, -22, -60, and the like.

Examples of magenta pigments include, but are not limited to, C.I. Pigment Red-5, -7, -12, -48, -48:1, -57, -112, -122, -123, -146, -168, -184, -202, and the like.

Examples of yellow pigments include, but are not limited to, C.I. Pigment Yellow-1, -2, -3, -12, -13, -14, -16, -17, -73, -74, -75, -83, -93, -95, -97, -98, -114, -128, -129, -138, -151, -154, -155, -180, and the like.

Alternatively, a pigment self-dispersible in water (self-dispersible pigment) may be used as the pigment. The self-dispersible pigments are pigments self-dispersible in water that have numerous water-solubilizing groups on the pigment surface and are dispersed in water stably without presence of a polymer dispersant. Specifically, the self-dispersible pigments are prepared, for example, by surface treatment, such as acid-base treatment, coupling agent treatment, polymer graft treatment, plasma treatment, or oxidative/reductive treatment, of common so-called pigments.

In addition to the surface-modified pigments described above, commercially available self-dispersible pigments including Cab-o-jet-200, Cab-o-jet-250, Cab-o-jet-260, Cab-o-jet-270, Cab-o-jet-300, IJX-444, and IJX-55 manufactured by Cabot; and Microjet Black CW-1 and CW-2 manufactured by Orient Chemical Industries may be used.

Alternatively, a resin-coated pigment may also be used as the pigment. It is called a microcapsulated pigment, and examples thereof include commercially available products from Dainippon Ink and Chemicals, Inc. and Toyo Ink Mfg. Co., Ltd., or alternatively, a microcapsulated pigment prepared for the invention may also be used.

On the other hand, the dye is preferably a dispersion dye. Typical examples of the dispersion dyes include C.I. Disperse Yellow-3, -5, -7, -8, -42, -54, -64, -79, -82, -83, -93, -100, -119, -122, -126, -160, -84:1, -186, -198, -204, and -224; C.I. Disperse Orange-13, -29, -31:1, -33, -49, -54, -66, -73, -119, and -163; C.I. Disperse Red-1, -4, -11, -17, -19, -54, -60, -72, -73, -86, -92, -93, -126, -127, -135, -145, -154, -164, -167:1, -177, -181, -207, -239, -240, -258, -278, -283, -311, -343, -348, -356, and -362; C.I. Disperse Violet-33; C.I. Disperse Blue-14, -26, -56, -60, -73, -87, -128, -143, -154, -165, -165:1, -176, -183, -185, -201, -214, -224, -257, -287, -354, -365, and -368; C.I. Disperse Green-6:1 and -9; and the like.

The thickness of the coating layer is preferably 5 nm or more and 100 nm or less, more preferably 10 nm or more and 90 nm or less, and still more preferably 25 nm or more and 75 nm or less. A thickness of the coating layer of more than 100 nm occasionally resulted in deterioration in color formation property.

The ratio of the thickness of the coating layer to the core particle radius (coating layer thickness/core particle radius) is preferably 0.2 or more and 2.5 or less, more preferably 0.2 or more and 2 or less, and still more preferably 0.25 or more and 1 or less. A ratio of the thickness of the coating layer to the core particle radius at less than 0.2 occasionally resulted in insufficient optical density, while that of more than 2.5 in deterioration in color formation property and generation of irregularity in the solid image region.

The weight ratio of the coating layer to the core particle (weight of coating layer/weight of core particle) is preferably 1 or more and 50 or less, more preferably 5 or more and 40 or less, and still more preferably 10 or more and 40 or less. When the weight ratio of the coating layer to the core particle of the colorant particle is less than 1 by mass, it was not always possible to obtain sufficient optical density, while a ratio of more than 50 occasionally resulted in deterioration in color formation property and generation of irregularity in the solid image region.

The radius of the core particles and the thickness of the coating layer can be determined by observing cross section of the colorant particle under a transmission electron microscope. Cross sections of colorant particles having a diameter in the range of the average diameter ±10% (μm), as determined by the Coulter counter method, were selectively used in measuring the thickness of the coating layer.

The radius of the core particles and the thickness of the coating layer were determined by using the boundary between the inner colorless core particle and the outer, for example, colored, coating layer. The radius of the core particles and the average thickness of the coating layer were determined by observing at least 20 colorant particles in a visual field, and the rate thereof was calculated therefrom.

Specifically, the radius of the core particles and the average thickness of the coating layer were determined by the following method: Ten radial lines at a constant angular distance (36 degrees) are drawn on a colorant particle image in transmission electron microgram; the core-particle radius and the thickness of the coating layer on the radial line are determined by using a ruler (at 10 positions). The core-particle radius and the coating layer thickness of the colorant particle is the average of the values at 10 positions.

The weight ratio between the core particle and coating layer is calculated, based on the core particle radius and coating layer thickness thus determined.

On the other hand, the number-average particle diameter of the adsorbed particles is preferably 10 to 200 nm, more preferably 20 to 150 μm, and still more preferably 30 to 100 nm. Colorant particles having a number-average particle diameter in the range above satisfy the requirements in dispersion stability and color formation property of the printed image at the same time.

The coverage rate of the adsorbed particles on a core particle is preferably 25% to 300%, more preferably 50% to 200%, and still more preferably 75% to 150%. It is possible to prevent the self fusion of particles during long-term storage and improve the long-term storage stability when the coverage rate is in the range above.

The coverage rate is determined as follows: The average particle diameters of core and adsorbed particles are determined by observation under an electron microscope. Assuming that the core and adsorbed particles are spherical in shape, it is possible to calculate the number of adsorbed particles N, when the adsorbed particles are coated on the surface of a core particle in a single layer, theoretically by the following Equation:

$$N = \frac{2 π}{\sqrt{3}} \times {( \frac{{D}_{core particle} \times {D}_{adsorbed particle}}{{D}_{adsorbed particle}} )}^{2}$$

D_{core particle} represents the number-average particle diameter of core particles; and D_{adsorbed particle} represents the number-average particle diameter of adsorbed particles.

It is possible to calculate the volume of the core or adsorbed particle by using the core particle diameter, adsorbed particle diameter, and adsorbed particle number, and the mass thereof by using the density of the core and adsorbed particles.

True mass ratio of adsorbed particles to core particle is calculated, based on the measured weight ratio of adsorbed particles to core particle obtained by the method above assuming that the adsorbed particles are coated in a single layer, and is used as the coverage rate.

The colorant particles in the configuration in which a coating layer is formed around core particle are prepared in the following manner. The method will be described, by referring the core particle as core region and the coating layer as shell region.

The colorant particles are prepared, for example, by a method depositing a shell-region component on the surface of the core region including a step of generating a plasma gas containing a reactive gas and a step of vaporizing the component for the shell region and conveying the colorant particles in the gas plasma containing a reactive gas, a method of depositing a polymer substance on the surface of the core region and additionally a shell region component thereon, a method of preparing the colorant particles by using a mechanochemical means such as angmill, theta composer, hybridizer, or mechanomill, or the like. Alternatively, the particles may be prepared by a so-called EA method, i.e., an encapsulated emulsion polymerization flocculation process. An example of the EA method will be described below. For example, the component particles for core region (hereinafter, referred to as “core particles”) are first dispersed in a solvent, to give a core particle dispersion. Separately, the component particles for shell region (hereinafter, referred to as “shell particles”) are dispersed in a solvent, to give a shell particle dispersion. Each dispersion may be stabilized then by adding a latex or a surfactant. If the core particle (core region) is made of a polymer substance, the core particle dispersion may be prepared, for example, by emulsion polymerization. Then, shell particles are deposited on the surface of the core particles in a layer (shell region) having a desired thickness, by adding the shell particle dispersion containing shell-region component particles to the core particle dispersion. In this way, colorant particles having the core/shell structure are obtained.

In preparing the core particle dispersion, the core particles may be aggregated into primary aggregates, for example, by changing the pH of the dispersion. In addition, a coagulant may be added, to obtain stabilized particle aggregate rapidly, or to obtain aggregate particles narrower in particle diameter distribution. The pH may be altered or a coagulant may also be added in depositing the shell particles on core particles, for obtaining stabilized particle aggregates rapidly or to obtain aggregate particles narrower in particle diameter distribution. Any one of the latexes, surfactants, and coagulants commonly used in the EA method may be used.

On the other hand, colorant particles in the configuration having adsorbed particles deposited around a core particle are prepared in the following manner. The colorant particles are prepared by making the adsorbed particles collide and adhere physically to the core particles by using a surface-modifying apparatus equipped with a mechanochemical means such as angmill, theta composer, hybridizer, or mechanomill.

The volume-average particle diameter of the colorant particles is preferably 30 nm or more and 250 nm or less. The volume-average particle diameter of colorant particles means a diameter of the colorant particle itself or a diameter of an additive-deposited particle when an additive such as dispersant is deposited on the colorant particle. The volume-average particle diameter was analyzed by using Microtrac UPA particle diameter analyzer 9340 (manufactured by Leeds & Northrup). The measurement was performed by placing 4 ml of ink in an analytical cell and measuring it according to a predetermined method. As for the parameters used in calculating the particle diameter, the viscosity used was an ink viscosity, and the density of dispersed particles was the density of colorant particles. The volume-average particle diameter is more preferably 60 nm or more and 250 nm or less, and still more preferably 150 nm or more and 230 nm or less. A volume-average particle diameter of the particles in liquid at less than 30 nm occasionally resulted in decrease in optical density, while that of more than 250 nm in deterioration in storage stability.

The particle diameters (volume- and number average particle diameters) and the particle diameter distribution index are determined by using Coulter counter TA-II (manufactured by Beckmann Coulter) and an electrolyte solution ISOTON-II (manufactured by Beckmann Coulter). In measurement, 0.5 to 50 mg of an analyte sample is added to 2 ml of an aqueous solution containing a dispersant surfactant, preferably aqueous 5% sodium alkylbenzenesulfonate solution. The mixture is added to 100 to 150 ml of the electrolyte solution above. The sample-suspended electrolyte solution is dispersed in an ultrasonic homogenizer for approximately 1 minute, and the volume- and number-average particle distributions are determined by analyzing particles of 2 to 60 μm in diameter, by using the Coulter Counter TA-II at an aperture having a diameter of 100 μm. The diameters determined from the volume- and number-averaged distributions were used respectively as the average diameters of the colorant particles.

The colorant is used in an amount in the range of 0.1 mass % or more and 50 mass % or less, preferably 1 mass % or more and 10 mass % or less. An ink colorant amount of less than 0.1 mass % may result in insufficient optical density of the resulting image, while a colorant amount of more than 50 mass % in instability in ink ejection property.

In addition to the colorant particles, the ink may contain a dispersant for dispersion of the colorant. The dispersant may be a nonionic, anionic, cationic, or amphoteric compound, or the like.

Examples thereof include copolymers of a α,β-ethylenic unsaturated group-containing monomer, and the like. Typical examples of the α,β-ethylenic unsaturated group-containing monomers include acrylic acid, methacrylic acid, crotonic acid, itaconic acid, itaconic monoesters, maleic acid, maleic monoesters, fumaric acid, fumaric monoesters, vinylsulfonic acid, styrenesulfonic acid, sulfonated vinylnaphthalene, vinylalcohol, acrylamide, methacryloxyethyl phosphate, bismethacryloxyethyl phosphate, methacryloxyethylphenyl acid phosphate, ethylene glycol dimethacrylate, diethylene glycol dimethacrylate, styrene, styrene derivatives such as α-methylstyrene and vinyltoluene, vinylcyclohexane, vinylnaphthalene, vinylnaphthalene derivatives, alkyl acrylate esters, phenyl acrylate ester, alkyl methacrylate esters, phenyl methacrylate ester, cycloalkyl methacrylate esters, alkyl crotonate esters, dialkyl itaconate esters, dialkyl maleate esters, and the like.

A polymer of the α,β-ethylenic unsaturated group-containing monomer or a copolymer of two or more of them is used as the polymer dispersant. Typical examples of the copolymers include styrene-styrenesulfonic acid copolymers, styrene-maleic acid copolymers, styrene-methacrylic acid copolymers, styrene-acrylic acid copolymers, vinylnaphthalene-maleic acid copolymers, vinylnaphthalene-methacrylic acid copolymers, vinyinaphthalene-acrylic acid copolymers, alkyl acrylate ester-acrylic acid copolymers, alkyl methacrylate ester-methacrylic acid copolymers, styrene-alkyl methacrylate ester-methacrylic acid copolymers, styrene-alkyl acrylate ester-acrylic acid copolymers, styrene-phenyl methacrylate ester-methacrylic acid copolymers, styrene-cyclohexyl methacrylate ester-methacrylic acid copolymers, and the like.

The dispersant preferably has a weight-average molecular weight of 2,000 to 50,000. A molecular weight of the polymer dispersant at less than 2,000 occasionally resulted in unstabilized colorant-particle dispersion, while that of more than 50,000 in increase in liquid viscosity and thus, deterioration in ejection efficiency. The weight-average molecular weight is more preferably 3,500 to 20,000.

The dispersant is used in an amount in the range of 0.01 mass % or more and 3 mass % or less. An addition amount of more than 3 mass % occasionally resulted in increase in liquid viscosity and destabilization of the liquid ejection property. Alternatively, an addition amount of less than 0.01 mass % occasionally resulted in deterioration of the dispersion stability of colorant particles. The amount of the dispersant added is more preferably 0.05 mass % or more and 2.5 mass % or less, and still more preferably 0.1 mass % or more and 2 mass % or less.

Hereinafter, the water-soluble organic solvent will be described. The water-soluble organic solvents favorably used include polyvalent alcohols, polyvalent alcohol derivatives, nitrogen-containing solvents, alcohols, sulfur-containing solvents, and the like. Typical examples of the polyvalent alcohols include ethylene glycol, diethylene glycol, propylene glycol, butylene glycol, triethylene glycol, 1,5-pentanediol, 1,2,6-hexanetriol, glycerol, and the like. Typical examples of the polyvalent alcohol derivatives include ethylene glycol monomethylether, ethylene glycol monoethylether, ethylene glycol monobutylether, diethylene glycol monomethylether, diethylene glycol monoethylether, diethylene glycol monobutylether, propylene glycol monobutylether, dipropylene glycol monobutylether, diglycerin ethyleneoxide adducts, and the like. Typical examples of the nitrogen-containing solvents include pyrrolidone, N-methyl-2-pyrrolidone, cyclohexylpyrrolidone, triethanolamine, and the like; those of the alcohols include ethanol, isopropyl alcohol, butyl alcohol, benzyl alcohol, and the like; and those of sulfur-containing solvents include thiodiethanol, thiodiglycerol, sulfolane, dimethylsulfoxide, and the like. Alternatively, propylene carbonate, ethylene carbonate, or the like may be used.

The water-soluble organic solvent may be used alone or in combination of two or more. The content of the water-soluble organic solvent is 1 mass % or more and 60 mass % or less, preferably 5 mass % or more and 40 mass % or less. When the amount of the water-soluble organic solvent in liquid is less than 1 mass %, it was occasionally not possible to obtain sufficiently high optical density, while, when it is more than 60 mass %, the liquid viscosity increased, leading to destabilization of liquid ejection properties.

The surface tension of the ink is preferably 20 mN/m or more and 60 mN/m or less, more preferably 20 mN or more and 45 mN/m or less, and still more preferably 20 mN/m or more and 35 mN/m or less. A surface tension of less than 20 mN/m may result in flooding of the liquid on the nozzle face of recording head and prohibit normal printing. On the other hand, a surface tension of more than 60 mN/m may lead to deterioration in the permeability of ink and elongation of the drying period.

The viscosity of the ink is preferably 1.2 m Pa·s or more and 25.0 m Pa·s or less, more preferably 1.5 m Pa·s or more and 10.0 m Pa·s, and still more preferably 1.8 m Pa·s or more and 5.0 m Pa·s. An ink viscosity of more than 25.0 m Pa·s occasionally resulted in deterioration in ejection efficiency, while an ink viscosity of less than 1.2 m Pa·s in deterioration in long-term ejection efficiency.

Water is added in the range where the surface tension and viscosity are in the ranges above. The amount of water added is not specifiedly limited, but preferably 10% or more and 99% or less, more preferably 30% or more and 80% or less by mass, with respect to the total amount of the liquid composition.

Hereinafter, the processing solution will be described. The processing solution contains at least a coagulant aggregating or insolubilizing the ink component, a water-soluble solvent, and water.

The coagulant aggregating or insolubilizing the ink component is, for example, a substance at least increasing the diameter of the colorant particles or a substance separating the ink colorant particle component from solvent when mixed with ink. The coagulants include inorganic electrolytes, organic acids, inorganic acids, organic amines, and the like.

Examples of the inorganic electrolytes include salts of hydrochloric acid, hydrobromic acid, hydroiodic acid, sulfuric acid, nitric acid, phosphoric acid, thiocyanic acid, an organic carboxylic acid such as acetic acid, oxalic acid, lactic acid, fumaric acid, citric acid, salicylic acid or benzoic acid, or an organic sulfonic acid, with an alkali metal ion such as lithium ion, sodium ion, or potassium ion, or with a polyvalent metal ion such as aluminum ion, barium ion, calcium ion, copper ion, iron ion, magnesium ion, manganese ion, nickel ion, tin ion, titanium ion, or zinc ion; and the like.

Typical examples thereof include alkali metal salts such as lithium chloride, sodium chloride, potassium chloride, sodium bromide, potassium bromide, sodium iodide, potassium iodide, sodium sulfate, potassium nitrate, sodium acetate, potassium oxalate, sodium citrate, and potassium benzoate; polyvalent metal salts such as aluminum chloride, aluminum bromide, aluminum sulfate, aluminum nitrate, aluminum sodium sulfate, aluminum potassium sulfate, aluminum acetate, barium chloride, barium bromide, barium iodide, barium oxide, barium nitrate, barium thiocyanate, calcium chloride, calcium bromide, calcium iodide, calcium nitrite, calcium nitrate, calcium dihydrogen phosphate, calcium thiocyanate, calcium benzoate, calcium acetate, calcium salicylate, calcium tartarate, calcium lactate, calcium fumarate, calcium citrate, copper chloride, copper bromide, copper sulfate, copper nitrate, copper acetate, iron chloride, iron bromide, iron iodide, iron sulfate, iron nitrate, iron oxalate, iron lactate, iron fumarate, iron citrate, magnesium chloride, magnesium bromide, magnesium iodide, magnesium sulfate, manganese nitrate, magnesium acetate, magnesium lactate, manganese chloride, manganese sulfate, manganese nitrate, magnesium dihydrogen phosphate, manganese acetate, manganese salicylate, manganese benzoate, manganese lactate, nickel chloride, nickel bromide, nickel sulfate, nickel nitrate, nickel acetate, tin sulfate, titanium chloride, zinc chloride, zinc bromide, zinc sulfate, zinc nitrate, zinc thiocyanate, and zinc acetate; and the like.

Typical examples of the organic acids include arginine acid, citric acid, glycine, glutamic acid, succinic acid, tartaric acid, cysteine, oxalic acid, fumaric acid, phthalic acid, maleic acid, malonic acid, lysine, malic acid, compounds represented by Formula (1), the derivatives of the compounds above, and the like.

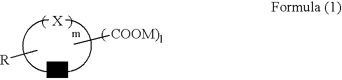

In the Formula above, X represents O, CO, NH, NR₁, S, or SO₂. R₁ represents an alkyl group; R₁ is preferably CH₃, C₂H₅, or C₂H₄OH. R represents an alkyl group; and R is preferably, CH₃, C₂H₅, C₂H₄OH. R may be present or absent in the Formula. X is preferably CO, NH, NR, or O, more preferably, CO, NH, or O. M represents a hydrogen atom, an alkali metal or an amine. M is preferably, H, Li, Na, K, monoethanolamine, diethanolamine, triethanolamine, or the like, more preferably, H, Na, or K, and still more preferably a hydrogen atom. n is an integer of 3 to 7. n is preferably a number making the heterocyclic ring a six- or five-membered ring, more preferably a five-membered ring. m is 1 or 2. The compound represented by Formula (1) may be a saturated or unsaturated ring, if it is a heterocyclic ring. 1 is an integer of 1 to 5.

Examples of the compounds represented by Formula (1) include compounds having a furan, pyrrole, pyrroline, pyrrolidone, pyrrone, thiophene, indole, pyridine, or quinoline structure and additionally a carboxyl group as its functional group. Typical examples thereof include 2-pyrrolidone-5-carboxylic acid, 4-methyl-4-pentanolide-3-carboxylic acid, furancarboxylic acid, 2-benzofurancarboxylic acid, 5-methyl-2-furancarboxylic acid, 2,5-dimethyl-3-furancarboxylic acid, 2,5-furan dicarboxylic acid, 4-butanolide-3-carboxylic acid, 3-hydroxy-4-pyrrone-2,6-dicarboxylic acid, 2-pyrrone-6-carboxylic acid, 4-pyrrone-2-carboxylic acid, 5-hydroxy-4-pyrrone-5-carboxylic acid, 4-pyrone-2,6-dicarboxylic acid, 3-hydroxy-4-pyrrone-2,6-dicarboxylic acid, thiophenecarboxylic acid, 2-pyrrolecarboxylic acid, 2,3-dimethylpyrrole-4-carboxylic acid, 2,4,5-trimethylpyrrole-3-propionic acid, 3-hydroxy-2-indolecarboxylic acid, 2,5-dioxo-4-methyl-3-pyrroline-3-propionic acid, 2-pyrrolidinecarboxylic acid, 4-hydroxyproline, 1-methylpyrrolidine-2-carboxylic acid, 5-carboxy-1-methylpyrrolidine-2-acetic acid, 2-pyridinecarboxylic acid, 3-pyridinecarboxylic acid, 4-pyridinecarboxylic acid, pyridinedicarboxylic acid, pyridinetricarboxylic acid, pyridine pentacarboxylic acid, 1,2,5,6-tetrahydro-1-methylnicotinic acid, 2-quinolinecarboxylic acid, 4-quinolinecarboxylic acid, 2-phenyl-4-quinolinecarboxylic acid, 4-hydroxy-2-quinolinecarboxylic acid, 6-methoxy-4-quinolinecarboxylic acid, and the like.

Favorable examples of the organic acids include citric acid, glycine, glutamic acid, succinic acid, tartaric acid, phthalic acid, pyrrolidonecarboxylic acid, pyrronecarboxylic acid, pyrrolecarboxylic acid, furancarboxylic acid, pyridinecarboxylic acid, coumarinic acid, thiophenecarboxylic acid, nicotinic acid, and the derivatives and salts thereof. More favorable examples thereof include pyrrolidonecarboxylic acid, pyrronecarboxylic acid, pyrrolecarboxylic acid, furancarboxylic acid, pyridinecarboxylic acid, coumarinic acid, thiophenecarboxylic acid, and nicotinic acid, and the derivatives and salts thereof. Still more favorable are pyrrolidonecarboxylic acid, pyrronecarboxylic acid, furancarboxylic acid, coumarinic acid, and the derivatives or salts thereof.

The organic amine compound for use in the processing solution may be a primary, secondary, tertiary or quaternary amine, or the salt thereof. Typical examples thereof include tetraalkylammonium, alkylamine, benzalkonium, alkylpyridinium, imidazolium, and polyamine compounds, the derivatives or salts thereof, and the like. Specific examples thereof include amylamine, butylamine, propanolanine, propylamine, ethanolamine, ethylethanolamine, 2-ethylhexylamine, ethylmethylamine, ethylbenzylamine, ethylenediamine, octylamine, oleylamine, cyclooctylamine, cyclobutylamine, cyclopropylamine, cyclohexylamine, diisopropanolamine, diethanolamine, diethylamine, di-2-ethylhexylamine, diethylenetriamine, diphenylamine, dibutylamine, dipropylamine, dihexylamine, dipentylamine, 3-(dimethylamino)propylamine, dimethylethylamine, dimethylethylenediamine, dimethyloctylamine, 1,3-dimethylbutylamine, dimethyl-1,3-propanediamine, dimethylhexylamine, amino-butanol, amino-propanol, amino-propanediol, N-acetylaminoethanol, 2-(2-aminoethylamino)-ethanol, 2-amino-2-ethyl-1,3-propanediol, 2-(2-aminoethoxy)ethanol, 2-(3,4-dimethoxyphenyl)ethylamine, cetylamine, triisopropanolamine, triisopentylamine, triethanolamine, trioctylamine, tritylamine, bis(2-aminoethyl)1,3-propanediamine, bis(3-aminopropyl)ethylenediamine, bis(3-aminopropyl)1,3-propanediamine, bis(3-aminopropyl)methylamine, bis(2-ethylhexyl)amine, bis(trimethylsilyl)amine, butylamine, butyl isopropylamine, propanediamine, propyldiamine, hexylamine, pentylamine, 2-methyl-cyclohexylamine, methyl-propylamine, methylbenzylamine, monoethanolamine, laurylamine, nonylamine, trimethylamine, triethylamine, dimethylpropylamine, propylenediamine, hexamethylenediamine, tetraethylenepentamine, diethylethanolamine, tetramethylammonium chloride, tetraethylammonium bromide, dihydroxyethyl steaylamine, 2-heptadecenyl-hydroxyethylimidazoline, lauryldimethylbenzylammonium chloride, cetylpyridinium chloride, stearamidomethylpyridinium chloride, diallyldimethylammonium chloride polymer, diallylamine polymer, monoallylamine polymer, and the like.

More favorable for use are triethanolamine, triisopropanolamine, 2-amino-2-ethyl-1,3-propanediol, ethanolamine, propanediamine, propylamine, and the like.

The coagulants for aggregating or insolubilizing the ink component may be used alone or in combination of two or more. The content of the coagulant in the liquid according to the invention is preferably 0.01 mass % or more and 30 mass % or less, more preferably 0.1 mass % or more and 15 mass % or less, and still more preferably 1 mass % or more and 15 mass % or less. A content of the coagulant added to the processing solution at less than 0.01 mass % occasionally resulted in insufficient aggregation of the colorant when the processing solution became in contact with ink and in deterioration in optical density, ink bleeding resistance and intercolor bleeding resistance, while that of more than 30 mass % in deterioration in ejection property and abnormal ejection of the liquid.

The processing solution may also contain a colorant. The colorant added to the processing solution is preferably a dye, a pigment having a sulfonic acid or sulfonate salt group on the surface, or a self-dispersible pigment. It is because the colorant is resistant to aggregation even in the presence of a coagulant. The storage stability of processing solution is preserved, if such a colorant is used. Compounds similar to those described above for ink colorant (i.e., colorant particles) may be used as the dye, the pigment having a sulfonic acid or sulfonate salt group on the surface, or the self-dispersing pigment.

When a pigment is used in the processing solution, the volume-average particle diameter of the pigment particles is preferably 30 nm or more and 250 nm or less, more preferably 50 nm or more and 200 nm or less, and still more preferably 75 nm or more and 175 nm or less. Particles in the processing solution having a volume-average particle diameter of less than 30 nm may lead to decrease in optical density, while those having a particle diameter of more than 250 nm to disturbed dispersion stability of the pigment.

The processing solution may contain a water-soluble organic solvent as the ink above. The content of the water-soluble organic solvent is preferably 1 mass % or more and 60 mass % or less, more preferably 5 mass % or more and 40 mass % or less. A content of the water-soluble organic solvent in the liquid at less than 1 mass % occasionally resulted in insufficient optical density, while that of more than 60 mass % in increase in liquid viscosity and destabilization of liquid ejection property.

In addition, the polymer dispersant used in the ink may be added to the processing solution.

The surface tension of the processing solution is preferably 20 mN/m or more and 45 mN/m or less, more preferably 20 mN or more and 39 mN/m or less, and still more preferably 20 mN/m or more and 35 mN/m or less. A surface tension of less than 20 mN/m may lead to exudation of the liquid onto nozzle face, prohibiting normal ink ejection. On the other hand, a surface tension of more than 45 mN/m may lead to deterioration in penetrability and elongation of drying period.

The viscosity of the processing solution is preferably 1.2 mPa·s or more and 25.0 mPa·s or less, more preferably 1.5 mPa·s or more and less than 10.0 mPa·s, and still more preferably 1.8 mPa·s or more and less than 5.0 mPa·s. When the viscosity of processing solutions is more than 25.0 mPa·s, the ejection efficiency thereof often decreased. On the other hand, a viscosity of less than 1.2 mPa·s occasionally resulted in deterioration in long-term storage stability.

Water is added in the range where the surface tension and viscosity are in the ranges above. The amount of water added is not specifiedly limited, but preferably 10% or more and 99% or less, more preferably 30% or more and 80% or less by mass with respect to the total amount of the inkjet liquid composition or the processing solution.

The number of the coarse particles of 5 μm or more in size in the mixture of the ink and the processing solution is preferably 1,000 piece/μL or more, more preferably 2,500 piece/mL or more, and still more preferably 5,000 piece/μL or more. A number of the coarse particles of 5 μm or more in size in the mixture of the ink and the processing solution ink at less than 1,000 piece/μL occasionally resulted in decrease in optical density.

The number of the coarse particles of 5 μm or more in size in the mixture of the ink and the processing solution was determined by mixing the two liquids at a mass ratio of 1:1, collecting a 2-μL sample while the mixture is agitated, and analyzing it by using Accusizer TM770 Optical Particle Sizer (manufactured by Particle Sizing Systems). The density of the colorant particles was inputted as the density of dispersion particles, a parameter used during measurement. The density of the colorant particle can be determined by measuring the powder obtained by heating and drying the colorant-particle dispersion, by using a densitometer, pycnometer, or the like.

Hereinafter, additives used as needed in the ink and the processing solution will be described.

The ink and the processing solution preferably contain a compound having three or more hydroxyl groups, which is effective for prevention of curl and cockle.

Examples of the compounds having three or more hydroxyl groups include sugar compounds (e.g., ribose, arabinose, xylose, lyxose, allose, aldose, glucose, mannose, gulose, idose, and talose), glycerol, trimethylolpropane, xylitol, pentaerythritol, and the like. Among them, sugar compounds, trimethylolpropane, xylitol, and pentaerythritol are specifiedly preferable for prevention of curling. These compounds may be used alone or in combination of two or more.

The content of the compound having three or more hydroxyl groups is preferably 10 to 60 mass %, more preferably 20 to 50 mass %, and still more preferably 25 to 40 mass %. A content in the range above is effective in preventing curl and cockle.

The ink and the processing solution may contain a surfactant. Compounds having a structure containing both hydrophilic and hydrophobic portions in the molecule are used effectively, and any one of anionic, cationic, amphoteric, and nonionic surfactants may be used as the surfactant according to the invention. In addition, the polymer dispersant described above may also be used.

Examples of the anionic surfactants favorably used include alkylbenzenesulfonic acid salts, alkylphenylsulfonic acid salts, alkylnaphthalenesulfonic acid salts, higher fatty acid salts, sulfuric acid ester salts of a higher fatty ester, sulfonic acid salts of a higher fatty ester, sulfuric acid ester and sulfonic acid salts of an higher alcohol ether, higher-alkyl sulfosuccinate salts, higher-alkyl phosphate ester salts, phosphoric ester salts of a higher alcohol ethylene oxide adduct, and the like; and, for example, dodecylbenzenesulfonic acid salts, cerylbenzene sulfonate salts, isopropylnaphthalenesulfonate salts, monobutylphenylphenol monosulfonate salts, monobutylbiphenyl sulfonate salts, monobutylbiphenyl sulfonate salts, di butylphenylphenol disulfonate salts, and the like.

Examples of the nonionic surfactants include polypropylene glycol ethylene oxide adducts, polyoxyethylene nonylphenylether, polyoxyethylene octylphenylether, polyoxyethylene dodecylphenylether, polyoxyethylene alkylethers, polyoxyethylene fatty acid esters, sorbitan fatty acid esters, polyoxyethylene sorbitan fatty acid esters, fatty acid alkylol amides, acetylene glycol, oxyethylene adducts of acetylene glycol, aliphatic alkanol amides, glycerol esters, sorbitan esters, and the like.

Examples of the cationic surfactants include tetraalkylammonium salts, alkylamine salts, benzalkonium salts, alkylpyridinium salts, imidazolium salts, and the like; and typical examples thereof include dihydroxyethylstearylamine, 2-heptadecenyl-hydroxyethylimidazoline, lauryldimethylbenzylammonium chloride, cetylpyridinium chloride, stearamidomethylpyridium chloride, and the like.

Alternatively, for example, a biosurfactant such as spiculisporic acid, rhamnolipid, or lysolecithin may also be used.

The amount of the surfactant added to the ink or the processing solution is preferably less than 10 mass %, more preferably in the range of 0.01 to 5 mass %, and still more preferably 0.01 to 3 mass %. An addition amount of 10 mass % or more occasionally resulted in decrease in optical density and deterioration in the storage stability of pigment ink.

Other additives added for control of properties, for example for improvement in ejection efficiency, include polyethyleneimine, polyamines, polyvinylpyrrolidone, polyethylene glycol, cellulose derivatives such as ethylcellulose and carboxymethylcellulose, polysaccharides and the derivatives thereof, other water-soluble polymers, polymer emulsions such as acrylic polymer emulsion, polyurethane emulsion, and hydrophilic latex; hydrophilic polymer gel, cyclodextrin, macrocyclic amines, dendrimers, crown ethers, urea and the derivatives thereof, acetamide, silicone surfactants, fluorochemical surfactants, and the like. In addition, an alkali metal compound such as potassium hydroxide, sodium hydroxide, or lithium hydroxide, a nitrogen-containing compound such as ammonium hydroxide, triethanolamine, diethanolamine, ethanolamine, or 2-amino-2-methyl-1-propanol, an alkali-earth metal compound such as calcium hydroxide, an acid such as sulfuric acid, hydrochloric acid, or nitric acid, a salt of a strong acid with an a weak alkali such as ammonium sulfate, or the like may be used additionally for adjustment of pH.

Further, other additives such as pH buffering agent, antioxidant, fungicide, viscosity adjuster, conductive substance, and ultraviolet absorbent may be added as needed.

### (Inkjet Ink Tank)

For example, the ink tank described in JP-A No. 2001-138541 and others may be used as the ink-jet ink tank of the invention. Such an ink tank is effective in preventing the change in ink properties stored therein during long-term storage and in preserving the ink ejection efficiency when ink is filled in the ink tank and ejected from a recording head.

### (Inkjet-Recording Method and Apparatus)

The inkjet-recording method of the invention is a method of ejecting the inkjet ink of the invention onto a recording medium. The inkjet-recording apparatus of the invention has a recording head ejecting the inkjet ink on the recording medium.

The inkjet-recording method (apparatus) of the invention uses the inkjet ink set of the invention in combination of an ink and a processing solution, and ejects the ink and the processing solution at a position in contact with each other. The method may be applied not only to common inkjet-recording apparatuses, but also to recording apparatuses equipped, for example, with a heater for control of ink drying, recording apparatuses equipped with an intermediate transfer mechanism that form an image on the intermediate and transfers the image onto a recoding medium such as paper, and the like. It is also applicable to apparatuses having, as needed, a fixing step (unit) of fixing the ink (including processing solution) transferred on the recording medium by applying at least heat (and pressure as needed).

In the inkjet-recording method (apparatus) according to the invention, the mass of a droplet of the ink or the processing solution is preferably 25 ng or less, more preferably 0.5 ng or more and 20 ng or less, and still more preferably 2 ng or more and 8 ng or less. A mass per droplet of more than 25 ng occasionally resulted in worsening of ink bleeding. It is because the contact angle of the ink (and the processing solution) to the recording medium changes according to the droplet amount, and a droplet tends to spread more over a paper in the surface direction when the droplet amount increases.

In an inkjet apparatus ejecting multiple droplets different in volume from one nozzle, the droplet amount means the minimum amount of droplet allowing printing.

The ink and the processing solutions are applied on a recording medium as they are brought into contact with each other; because the contact between the ink and the processing solution results in aggregation of the ink by action of the coagulant, such a method offers a method superior in color formation property and optical density, resistant to irregularity in solid image, ink bleeding and intercolor bleeding, and shorter in drying period. The ink and processing solutions may be ejected either close to each other or overlapped, if they become in contact with each other.

In application on the recording medium, the processing solution is first applied and then the ink is applied. Prior application of the processing solution enables more effective aggregation of the ink component. The ink may be applied any time after application of the processing solution. The ink is preferably applied in 1 second or less, more preferably 0.5 second or less, after application of the processing solution.

In the inkjet-recording method (apparatus) according to the invention, the mass ratio of the ink to the processing solution ejected for forming a pixel is 1:20 to 20:1, more preferably 1:10 to 10:1, and still more preferably 1:5 to 5:1. Excessively large or small ratio of the amount of the processing solution ejected to the amount of the ink ejected occasionally resulted in insufficient aggregation, deterioration in optical density, worsening of ink bleeding and intercolor bleeding. The image pixel is a lattice point constituting a desired image when the image is divided both in the main- and sub-scanning directions into the minimum distance on which the ink can be ejected, and an image controlled well in color and density is formed only by providing an ink set suitable for each image pixel.

The inkjet-recording method (apparatus) according to the invention is preferably a thermal inkjet recording method or a piezo ink-jet recording method, for improvement in resistance to ink bleeding and intercolor bleeding. Although the reason is unclear, in the case of the thermal ink-jet recording method, the viscosity of ink is lowered by heating when it is ejected, but the viscosity thereof become drastically higher due to decrease in temperature when it is ejected onto a recording medium. This phenomenon may be the reason why the ink-jet recoding method is effective in suppressing the ink bleeding and intercolor bleeding. In contrast in the case of piezo ink-jet process, it is possible to eject high-viscosity liquid and suppress spread of the high-viscosity liquid on the surface of recording medium, and thus the piezo inkjet-recording method of the invention is effective in suppressing the ink bleeding and intercolor bleeding.

In the inkjet-recording method (apparatus) according to the invention, the ink and the processing solution are preferably replenished or supplied to the recording heads from the respective ink tanks (including a tank for processing solution) filled with the ink and the processing solution. The ink tanks are preferably removable cartridges, and it becomes easier to replenish the ink and processing solutions by exchanging the cartridge ink tanks.

Hereinafter, favorable embodiments of the inkjet-recording apparatus of the invention will be described in detail with reference to drawings. In the Figure, the same codes are allocated to the units having essentially the same functions, and thus, duplicated description is avoided.

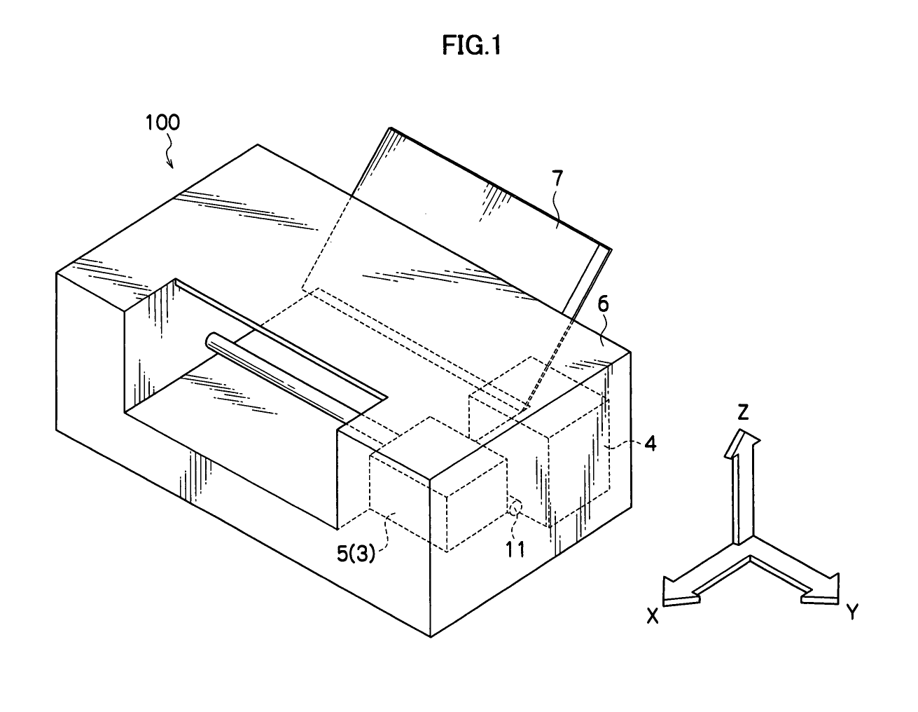

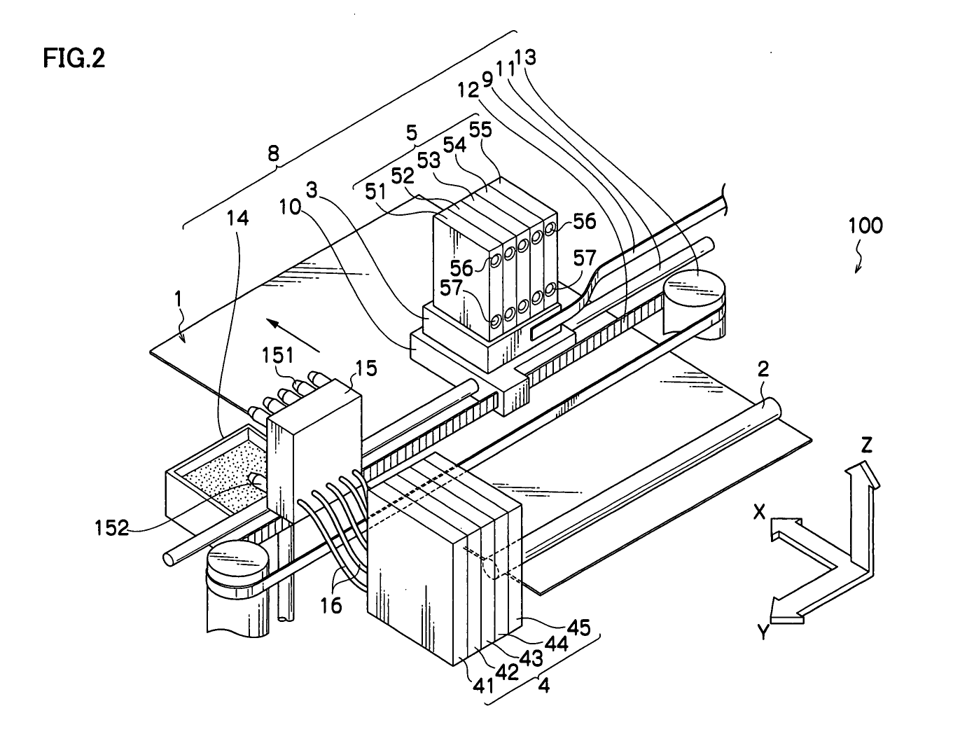

FIG. 1 is a perspective view illustrating the configuration of an exemplary embodiment of the inkjet-recording apparatus of the invention. FIG. 2 is a perspective view illustrating the basic configuration inside the inkjet-recording apparatus (hereinafter, referred to as “image-forming apparatus”) shown in FIG. 1.

The image-forming apparatus 100 in this embodiment has a configuration in which an image is formed by operations based on the inkjet-recording method of the invention described above. As shown in FIGS. 1 and 2, the image-forming apparatus 100 mainly has an external cover 6, a tray 7 carrying a specified amount of recording media 1 such as plain paper, a conveyor roller (conveying unit) 2 of conveying the recording medium 1 one by one into the image-forming apparatus 100, an image-forming unit 8 (image-forming means) of forming an image by ejecting inks and a processing solution onto the surface of the recording medium 1, and a main ink tank unit 4 of supplying the inks and the processing solution to a sub-ink tank unit 5 in the image-forming unit 8 therefrom.

The conveyor roller 2 is a paper-feeding mechanism consisting of a pair of rotatable rollers that is installed in the image-forming apparatus 100 that hold a recording medium 1 stored in the tray 7 and convey a specified amount of recording media 1 at a specified timing one by one into the apparatus 100.

The image-forming unit 8 forms an ink image on the surface of the recording medium 1. The image-forming unit 8 mainly has a recording head 3, a sub-ink tank unit 5, a power/signal cable 9, a carriage 10, a guide rod 11, a timing belt 12, drive pulleys 13, and a maintenance unit 14.

The sub-ink tank unit 5 has sub-ink tanks 51, 52, 53, 54, and 55 respectively containing inks different in color and a processing solution for ejection from the recording head. For example, four inks in different color, black (K), yellow (Y), magenta (M), and cyan (C), and a processing solution are fed from the main ink tank unit 4 to fill respective sub-ink tanks. When the processing solution contains a colorant, there is no need for installing a sub-ink tank for processing solution additionally.

Each of the sub-ink tank unit 5 has an exhaust vent 56 and a replenishing hole 57. When the recording head 3 moves to a stand-by position (or replenishing position), ventilation pins 151 and replenishing pins 152 in a replenishing apparatus 15 are connected to the exhaust vents 56 and the replenishing holes 57, and thus, the entire sub-ink tank unit 5 and the replenishing apparatus 15 are connected to each other.

The replenishing apparatus 15 is also connected to the main ink tank 4 unit via replenishing tubes 16, and the inks and the processing solution are replenished by the replenishing apparatus 15 from the main ink tank unit 4 through the replenishing holes 57 to the sub-ink tank 5.

The main ink tank unit 4 also has main ink tanks 41, 42, 43, 44, and 45 respectively storing inks different in color and a processing solution. For example, black ink (K), yellow ink (Y), magenta ink (M) and cyan ink (C), and a processing liquid are filled respectively therein, and these main ink tanks are detachably installed in the image-forming apparatus 100. When the processing solution contains a colorant, there is no need for installing a main ink tank for the processing solution additionally.

In addition, the power supply/signal cable 9 and the sub-ink tank unit 5 are connected to recording head 3, and when external recording image information is inputted through the power supply/signal cable 9 to the recording head 3, the recording head 3 withdraws a specified amount of ink form each sub-ink tank unit 5 and ejects it on the surface of recording medium based on the recording image information. The power supply/signal cable 9 also has a role of supplying to the recording head 3 a power needed for driving the recording head 3, in addition to the recording image information.

The recording head 3 is placed and held on the carriage 10, and a guide rod 11 and a timing belt 12 supported by drive pulleys 13 are connected to the carriage 10. In such a configuration, the recording head 3 can move along the guide rod 11 in the direction parallel with the surface of the recording medium 1 and in the direction Y (main scanning direction) perpendicular to the conveyor direction X (secondary scanning direction) of the recording medium 1.

The image-forming apparatus 100 has a control unit (not shown in the Figure) of determining the timing of driving the recording head 3 and the carriage 10 based on the recording image information. In this manner, it is possible to form an image based on the recording image information continuously in a specified region on the surface of the recording medium 1 traveling in the conveyor direction X at a specified speed.

A maintenance unit 14 is connected to a vacuum apparatus (not shown in the Figure) via a tube. In addition, the maintenance unit 14 is connected to the nozzle region of the recording head 3, and plays a role of withdrawing ink from the nozzle of the recording head 3 by bringing the nozzle of recording head 3 into a reduced-pressure state. By installation of the maintenance unit 14, it becomes possible to remove the undesirable ink deposited on the nozzle during operation of the image-forming apparatus 100 as needed and to reduce vaporization of ink from nozzles in the stand-by mode.

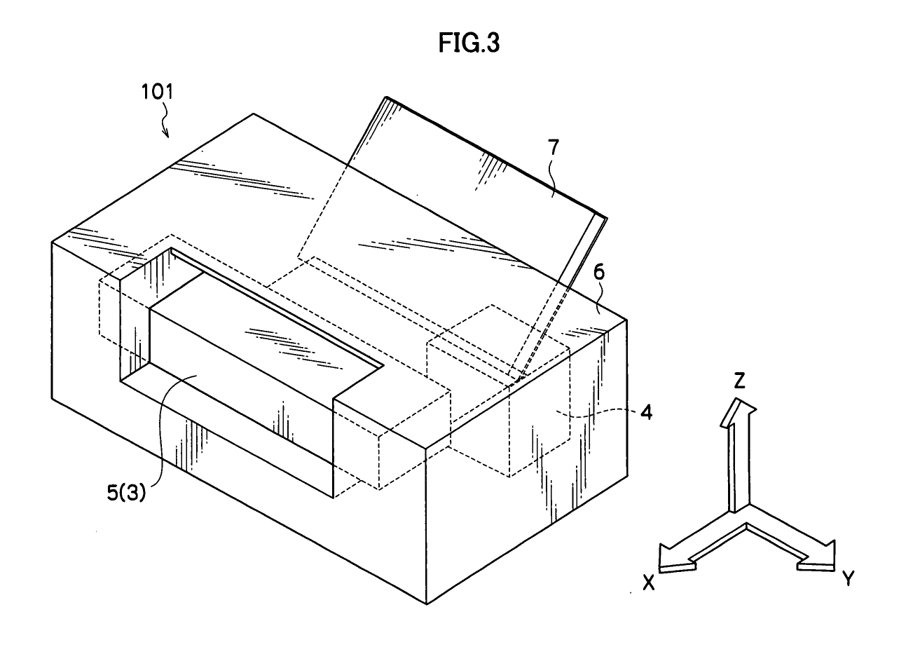

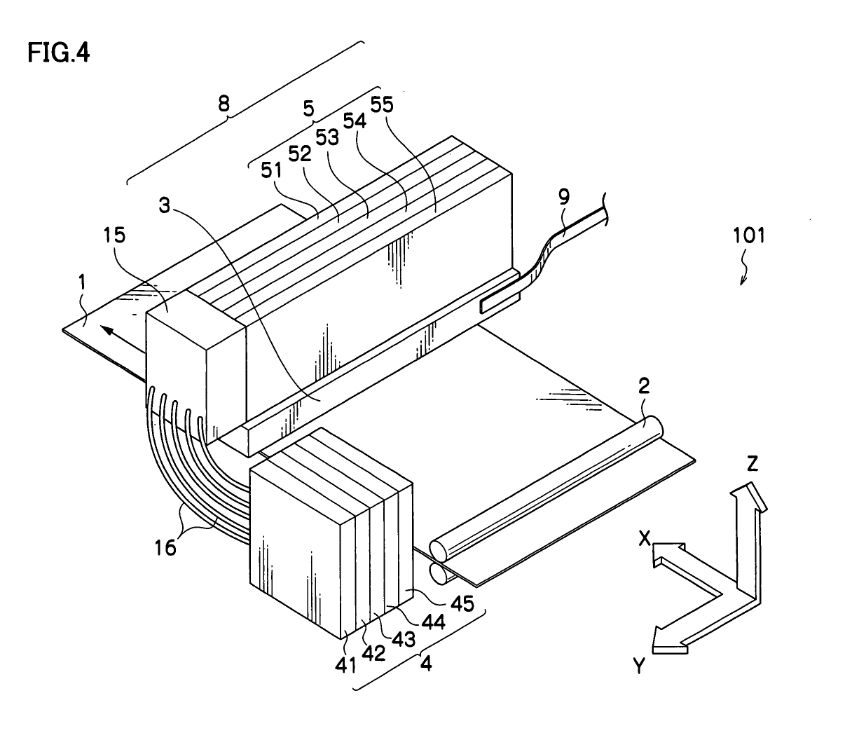

FIG. 3 is a perspective view illustrating the configuration of another exemplary embodiment of the inkjet-recording apparatus of the invention. FIG. 4 is a perspective view illustrating the basic configuration of the inkjet-recording apparatus (hereinafter, referred to as “image-forming apparatus”) shown in FIG. 3. The image-forming apparatus 101 in this embodiment has a configuration in which an image is formed by operations based on the inkjet-recording method of the invention described above.

The image-forming apparatus 101 shown in FIGS. 3 and 4 has a recording head 3 having a width the same as or larger than that of the recording medium 1, but does not have a carriage mechanism and has a paper-feeding mechanism feeding paper in the secondary scanning direction (conveyor direction of recording medium 1, indicated by arrow X); but, for example, a belt-shaped paper-feeding mechanism may be used instead of the conveyor roller 2 shown in this embodiment.

Although not shown in the Figure, nozzles ejecting inks in various colors (including a processing solution) are placed sequentially in the secondary scanning direction, together with sub-ink tanks 51 to 55 sequentially arranged in the secondary scanning direction (conveyor direction of recording medium 1, indicated by arrow X). Other configuration is the same as that of the image-forming apparatus 100 shown in FIGS. 1 and 2, and description thereof is omitted. Although the sub-ink tank unit 5 is shown in the Figure as it is always connected to a replenishing apparatus 15 because the recording head 3 does not move, the tank may be connected to the replenishing apparatus 15 only when the inks are replenished.

In the image-forming apparatus 101 shown in FIGS. 3 and 4, printing in the width direction of the recording medium 1 (main scanning direction) is performed all at once by the recording head 3, and thus, the apparatus is simpler in structure than those having a carriage mechanism and faster in printing speed.

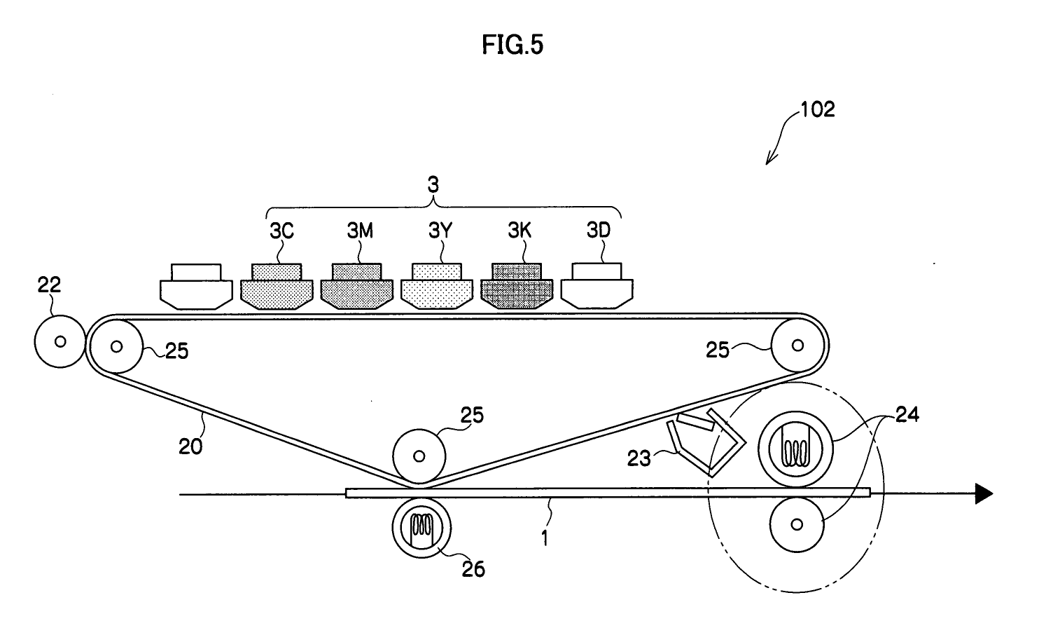

FIG. 5 is a schematic view illustrating the basic configuration inside another exemplary embodiment of the inkjet-recording apparatus of the invention (hereinafter, referred to as “image-forming apparatus”). The image-forming apparatus 102 in the present embodiment has a configuration forming an image according to the inkjet-recording method of the invention described above.

The image-forming apparatus 102 shown in FIG. 5 has an intermediate transfer belt 20, recording heads 3 ejecting inks in various colors and a processing solution onto the intermediate transfer belt 20 surface ((cyan recording head 3C, magenta recording head 3M, yellow recording head 3Y, black recording head 3K, and processing solution recording head 3D)) placed on the periphery, an liquid-absorbing roll 22 absorbing excessive inks and processing solution, a transfer roll 26 transferring the inks and processing solution from the intermediate transfer belt 20 onto the recording medium 1, a cleaner 23 removing the inks and processing solution remaining on the intermediate transfer belt 20 surface after transfer, as well as a fixing roll pair 24 fixing the transferred inks (including the processing solution) on the recording medium 1.

The intermediate transfer belt 20 is stretched by three extension rolls 25, and a transfer roll 26 is placed at a position facing one of them as it is separated by the belt.

In the image-forming apparatus 102 shown in FIG. 5, the inks and the processing solution are ejected from respective recording heads 3 onto the intermediate transfer belt 20 according to image information. Then, the inks and processing solution ejected on the intermediate transfer belt 20 surface are absorbed with the liquid-absorbing roll 22, transferred onto the recording medium 1 by applying heat and pressure by the transfer roll 26, and then, fixed by applying heat and pressure by the fixing roll pair 24. In this way, an image is formed on the recording medium.

### EXAMPLES

Hereinafter, the present invention will be described specifically with reference to Examples. However, the invention is not restricted by these Examples. The following abbreviations were used:

“mv”: volume-average particle diameter

“nm”: number-average particle diameter

“Tg”: glass transition temperature

“Mw”: weight-average molecular weight

(Ink A)

| | | |
|---|---|---|
| Styrene-n-butyl methacrylate-methacrylic acid | 100 | parts by mass |
| copolymer particles: (mn: 0.1 μm, | | |
| Tg: ca. 71° C., Mw: 28,000) | | |
| C.I. Pigment Blue 15:3: | 50 | parts by mass |
| Polyvinylalcohol: | 1 | part by mass |

The components at the material ratio above are placed in a sample mill, and mixed and agitated for approximately 30 seconds; a small amount of an aqueous bactericide solution (Proxel aqueous solution, manufactured by Arch Chemicals, Inc.) and an aqueous sodium hydroxide solution are added thereto; and the mixture is processed intermittently in a mechanofusion system. The particle diameter of the particles therein is determined after each intermittent driving, and the agitation is terminated when the particle diameter becomes approximately 0.2 μm, to give colorant particles a-1.

| | |
|---|---|
| Colorant particle a-1: | 100 parts by mass |
| Styrene-n-butyl methacrylate-methacrylic acid | 20 parts by mass |
| copolymer (neutralized partially with NaOH): | |
| Ion-exchange water: | 380 parts by mass |

The components at the composition above are mixed and agitated; the colorant particles are dispersed therein while the mixture is processed in an ultrasonic dispersing machine for 30 minutes. The dispersion is further centrifuged in a centrifugal separator (8,000 rpm×30 minute), to give a dispersion. After removal of water in the dispersion, the solid matter concentration thereof is calculated.

| | |
|---|---|
| Dispersion above: | (adjusted to solid content of 15 mass %) |
| Glycerol: | 15 mass % |
| Propylene glycol: | 5 mass % |
| Polyoxyethylene laurylether | 1 mass % |
| (manufactured by Kao | |
| Corporation): | |
| Ion-exchange water: | balance |

The components above are mixed at the ratio above. The mixed liquid is filtered through a 5-μm membrane filter, to give an ink A.

(Ink B)

| | |
|---|---|
| Polyester particles: | 100 parts by mass |
| (mn: 0.15 μm, Tg: ca. 20° C., Mw: 21,000) | |
| Black Pearls L (manufactured by Cabot): | 80 parts by mass |
| Polyvinylalcohol: | 1 part by mass. |

The components at the material ratio above are placed in a sample mill, and mixed and agitated for approximately 30 seconds; a small amount of an aqueous bactericide solution (Proxel aqueous solution, manufactured by Arch Chemicals, Inc.) and an aqueous sodium hydroxide solution are added thereto; and the mixture is processed intermittently in a mechanofusion system. The particle diameter of the particles therein is determined after each intermittent driving, and the agitation is terminated when the particle diameter becomes approximately 0.25 μm, to give colorant particles b-1.

| | |
|---|---|
| Colorant particle b-1: | 100 parts by mass |
| Styrene-n butyl methacrylate-acrylic acid | 20 parts by mass |
| (partially neutralized with NaOH): | |
| Ion-exchange water: | 380 parts by mass |

The components at the composition above are mixed and agitated; the colorant particles are dispersed while the mixture is processed in an ultrasonic dispersing machine for 30 minutes. The dispersion is further centrifuged in a centrifugal separator (8,000 rpm×30 minute), to give a dispersion. After removal of water in the dispersion, the solid matter concentration thereof is calculated.

| | |
|---|---|
| Dispersion above: | (adjusted to a solid |
| | content of 20 mass %) |
| Glycerol: | 15 mass % |
| Diethylene glycol: | 5 mass % |
| Olfin E1010 (manufactured by Nisshin | 1 mass % |
| Chemical Industry Co., Ltd.): | |
| Ion-exchange water: | balance |

The components above are mixed at the ratio above. The mixed liquid is filtered through a 5-μm membrane filter, to give an ink B.

(Ink C)

| | |
|---|---|
| Styrene-n-butyl methacrylate-acrylic acid copolymer | 100 parts by mass |
| particles: (mn: 0.12 μm, Tg: ca. 55° C., | |
| Mw: 15,000) | |
| C.I. Pigment Blue 15:3 (self-dispersible pigment): | 75 parts by mass |

First, styrene-n-butyl methacrylate-acrylic acid copolymer particles are added to ion-exchange water, and the mixture is treated in a homogenizer, to give a dispersion. A C.I. Pigment Blue 15:3 dispersion is added to the dispersion at the specified addition ratio above, and the mixture is blended and agitated. The dispersion is then made acidic, heated to 90° C., and stirred for 3 hours. The aggregate obtained is collected by filtration and washed with ion-exchange water.

The aggregate is added into ion-exchange water; the mixture is adjusted to pH 8.5 with an aqueous sodium hydroxide solution, and treated in an ultrasonic dispersing machine for 30 minutes, to give a dispersion. After removal of water in the dispersion, the solid matter concentration is calculated.

| | |
|---|---|
| Dispersion above: | (adjusted to a solid content |
| | of 10 mass %) |
| Glycerol: | 10 mass % |
| Ethylene glycol: | 10 mass % |
| Diethylene glycol monobutylether: | 5 mass % |
| Olfin E1010 (manufactured by Nisshin | 1 mass % |
| Chemical Industry Co, Ltd.): | |
| Ion-exchange water: | balance |

The components above are mixed at the ratio above. The mixed liquid is filtered through a 5-μm membrane filter, to give an ink C.

(Ink D)

| | |
|---|---|
| Styrene-n-butyl methacrylate-dimethylamino | 100 parts by mass |
| methacrylate copolymer particles: (mn: 0.15 μm, | |
| Tg: ca. 45° C., Mw: 14,000) | |
| C.I. Pigment Blue 15:3 (self-dispersible pigment): | 70 parts by mass |

First, styrene-n-butyl methacrylate-dimethylamino methacrylate copolymer particles are added into ion-exchange water and treated in a homogenizer, to give a dispersion. A dispersion of C.I. Pigment Blue 15:3 is added to the dispersion at the specified addition ratio above, and the mixture is agitated. The dispersion is then adjusted to a pH in the range of 7 to 7.5, heated to 90° C., and stirred for 3 hours. The aggregate obtained is collected by filtration and washed with ion-exchange water.

The aggregate is added in ion-exchange water; the mixture is adjusted to pH 8.5 with an aqueous sodium hydroxide solution and treated in an ultrasonic dispersing machine for 30 minutes, to give a dispersion. After removal of water in the dispersion, the solid matter concentration is calculated.

| | |
|---|---|
| Dispersion above: | (adjusted to a solid |
| | content of 10 mass %) |
| Glycerol: | 10 mass % |
| Ethylene glycol: | 10 mass % |
| Diethylene glycol monobutylether: | 5 mass % |
| Olfin E1010 (manufactured by Nisshin Chemical | 1 mass % |
| Industry Co., Ltd.): | |
| Ion-exchange water: | balance |

The components above are mixed at the ratio above. The mixed liquid is filtered through a 5-μm membrane filter, to give an ink D.

(Ink E)

| | |
|---|---|
| Styrene-butadiene particles (SR-130, manufactured | 100 parts by mass |
| by Nippon A&L Inc.): (mn: 0.20 μm, Tg: ca. | |
| −6° C., Mw: unmeasurable because partially | |
| crosslinked) | |
| C.I. Pigment Red 122 (self-dispersible pigment): | 50 parts by mass |

Styrene-butadiene particles and C.I. Pigment Red 122 dispersion are mixed at the specified addition ratio above, and the mixture is agitated. The dispersion is then made acidic. The aggregate obtained is collected by filtration and washed with ion-exchange water.

The aggregate is added into ion-exchange water; the mixture is adjusted to pH 8.5 with an aqueous sodium hydroxide solution and treated in an ultrasonic dispersing machine for 30 minutes, to give a dispersion. After removal of water in the dispersion, the solid matter concentration is calculated.

| | |
|---|---|
| Dispersion above: | (adjusted to a solid |
| | content of 10 mass %) |
| Glycerol: | 15 mass % |
| Diethylene glycol: | 5 mass % |
| 1,2-Hexanediol: | 5 mass % |
| Polyoxyethylene 2-ethylhexylether | 1 mass % |
| (manufactured by Aoki Oil Industrial Co., Ltd.): | |
| Ion-exchange water: | balance |

The components above are mixed at the ratio above. The mixed liquid is filtered through a 5-μm membrane filter, to give an ink E.

(Ink F)

| | |
|---|---|
| Styrene-n-butyl methacrylate- | 100 parts by mass |
| methacrylic acid copolymer particles: | |
| (mn: 0.70 μm, Tg: ca. 30, Mw: 28,000) | |

An aqueous sodium hydroxide solution is added to the particles; and the mixture is processed intermittently in a mechanofusion system, to give complex particles. The particle diameter is determined after each intermittent driving, and the agitation is terminated when the particle diameter becomes approximately 0.7 μm.

Then, 25 mass parts of silica (Aerosil 130, manufactured by Degussa, mn: 0.016 μm) is added to the mechanofusion system, and the mixture is processed intermittently, to give composite particles. The particle diameter is determined after each intermittent driving, and the agitation is terminated when the particle diameter becomes approximately 0.9 μm, to give colorant particles f-1.

| | |
|---|---|
| Colorant particle f-1: | 100 parts by mass |
| Styrene-n butyl methacrylate-acrylic acid | 25 parts by mass |
| (partially neutralized with NaOH): | |
| Ion-exchange water: | 375 parts by mass |

The components above are mixed at the ratio above. The mixture is treated in an ultrasonic dispersing machine for 30 minutes, to give a colorant particle dispersion. The colorant particle dispersion is centrifuged (8,000 rpm×30 minutes), for separating bulky particles; and the solid content is determined by removing water.

| | (adjusted to a solid |
|---|---|
| Dispersion above: | content of 7 mass %) |
| Glycerol: | 5 mass % |
| Propylene glycol: | 5 mass % |
| Glucose: | 15 mass % |
| Olfin E1010 (manufactured by | 1 mass % |
| Nisshin Chemical Industry Co., Ltd.): | |
| Ion-exchange water: | balance |

The components above are mixed at the ratio above. The mixed liquid is filtered through a 5-μm membrane filter, to give an ink F.

(Ink G)

| | |
|---|---|
| C.I. Pigment Blue 15:3 (self-dispersible pigment): | 5 mass % |
| Glycerol: | 5 mass % |
| Propylene glycol: | 5 mass % |
| Glucose: | 20 mass % |
| Polyoxyethylene laurylether | 1 mass % |
| (manufactured by Kao Corporation): | |
| Ion-exchange water: | balance |

The components above are mixed at the ratio above. The mixed liquid is filtered through a 5-μm membrane filter, to give an ink G.

(Ink H)

| | |
|---|---|
| C.I. Pigment Blue 15:3 (self-dispersible pigment): | 5 mass % |
| Polyester particles: | 5 mass % |
| (mn: 0.15 μm, Tg: −25° C., Mw: 17,000) | |
| Glycerol: | 5 mass % |
| Propylene glycol: | 5 mass % |
| Glucose: | 20 mass % |
| Olfin E1010 (manufactured by | 1 mass % |
| Nisshin Chemical Industry Co., Ltd.): | |
| Ion-exchange water: | balance |

The components above are mixed at the ratio above. The mixed liquid is filtered through a 5-μm membrane filter, to give an ink H.

(Ink I)

| | |
|---|---|
| Styrene-methyl methacrylate- | 100 parts by mass |
| methacrylic acid copolymer particles: | |
| (mn: 0.1 μm, Tg: ca. 82° C., Mw: 80,000) | |
| C.I. Pigment Blue 15:3: | 50 parts by mass |
| Polyvinylalcohol: | 1 part by mass |

The components are mixed and agitated for approximately 30 seconds in a sample mill; a small amount of an aqueous bactericide solution (Proxel aqueous solution, manufactured by Arch Chemicals, Inc.) and an aqueous sodium hydroxide solution are added thereto; and the mixture is processed intermittently in a mechanofusion system. The particle diameter is determined after each intermittent driving, and the agitation is terminated when the particle diameter becomes approximately 0.4 μm, to give colorant particles i-1.

| | |
|---|---|
| Colorant particles i-1: | 100 parts by mass |
| Styrene-n-butyl methacrylate-methacrylic acid | 10 parts by mass |
| (partially neutralized with NaOH): | |
| Ion-exchange water: | 390 parts by mass |

The components are mixed and agitated for approximately 30 seconds; and the mixture is treated in an ultrasonic dispersing machine for 30 minutes, for dispersion of the colorant particles. The dispersion is centrifuged (8,000 rpm×30 minute), to give a dispersion. After removal of water in the dispersion, the solid matter concentration is calculated.

| | |
|---|---|
| Dispersion above: | (adjusted to a solid |
| | content of 10 mass %) |
| Glycerol: | 15 mass % |
| Propylene glycol: | 5 mass % |
| Olfin E1010 (manufactured by | 1 mass % |
| Nisshin Chemical Industry Co., Ltd.): | |
| Ion-exchange water: | balance |

The components above are mixed at the ratio above. The mixed liquid is filtered through a 5-μm membrane filter, to give an ink I.

(Ink J)

| | |
|---|---|
| Styrene-n-butyl methacrylate-acrylic acid | 100 parts by mass |
| copolymer particles: (mn: 0.04 μm, Tg: ca. 60, | |
| Mw: unmeasurable because partially crosslinked) | |
| Silica (Aerosil 130, manufactured by Degussa): | 150 parts by mass |
| (mn: 0.016 μm) | |

An aqueous sodium hydroxide solution is added to the particles above; and the mixture is processed intermittently in a mechanofusion system, to give composite particles. The particle diameter is determined after each intermittent driving, and the agitation is terminated when the particle diameter becomes approximately 0.05 μm, to give colorant particles j-1.

| | |
|---|---|
| Colorant particle j-1: | 100 parts by mass |
| Styrene-n-butyl methacrylate-acrylic acid copolymer | 10 parts by mass |
| (partially neutralized with NaOH): | |
| Ion-exchange water: | 390 parts by mass |

The components above are mixed at the ratio above. The mixture is treated in an ultrasonic dispersing machine for 30 minutes, to give a colorant particle dispersion. The colorant particle dispersion is centrifuged (8,000 rpm×30 minutes), for separating bulky particles; and the solid content is determined by removing water.

| | |
|---|---|
| Dispersion above: | (adjusted to a solid |
| | content of 7 mass %) |
| Glycerol: | 5 mass % |
| Propylene glycol: | 5 mass % |
| Glucose: | 15 mass % |
| Olfin E1010 (manufactured by | 1 mass % |
| Nisshin Chemical Industry Co., Ltd.): | |
| Ion-exchange water: | balance |

The components above are mixed at the ratio above. The mixed liquid is filtered through a 5-μm membrane filter, to give an ink J.

(Ink K)

| | |
|---|---|
| Styrene-n-butyl methacrylate- | 100 parts by mass |
| dimethylamino methacrylate copolymer | |
| particles: (mn: 0.15 μm, Tg: ca. 45° C., Mw: 14,000) | |
| C.I. Pigment Blue 15:3 (self-dispersible pigment): | 70 parts by mass |

First, styrene-n-butyl methacrylate-dimethylamino methacrylate copolymer particles are added into ion-exchange water, and the mixture is treated in a homogenizer, to give a dispersion. A C.I. Pigment Blue 15:3 dispersion is added to the dispersion at the specified addition ratio above, and the mixture is agitated. The dispersion is then adjusted in the pH range of 7 to 7.5, heated to 90° C., and stirred for 3 hours. The aggregate obtained is collected by filtration and washed with ion-exchange water.

The aggregate is added into ion-exchange water; the mixture is adjusted to pH 8.5 with an aqueous sodium hydroxide solution and treated in an ultrasonic dispersing machine for 30 minutes, to give a dispersion. After removal of water in the dispersion, the solid matter concentration is calculated.

| | |
|---|---|
| Dispersion above: | (adjusted to a solid |
| | content of 10 mass %) |
| Xylitol: | 20 mass % |
| Glucose: | 10 mass % |
| Olfin E1010 (manufactured by | 1.5 mass % |
| Nisshin Chemical Industry Co., Ltd.): | |
| Ion-exchange water: | balance |

The components above are mixed at the ratio above. The mixed liquid is filtered through a 5-μm membrane filter, to give an ink K.

### Examples 1 to 8 and Comparative Examples 1 to 3

A printing test is performed by using each of the inks shown in Table 1. The test is preformed by printing an image on FX-P paper (manufactured by Fuji Xerox Co., Ltd.) while ejecting ink by using a test print head at 800 dpi having 256 nozzles (thermal printer, droplet amount: 14 ng), and the resulting image is evaluated according to the criteria below. The test is conducted under normal environment (temperature: 23±0.5° C., humidity: 55±5% R.H). Evaluation results and properties of the inks are summarized in Table 1.

### -Fixing Property-

The fixing property is evaluated by the method below, both after the image is fixed at room temperature (temperature: 23±0.5° C.) and after heated to 90° C.

White plain paper (manufactured by Fuji Xerox Co., Ltd., C2 paper) and a weight of 5 kg having a bottom face area of 10 cm² are placed on the printed image region, and the white paper is pulled toward the non-image-printed region. After removal of the white paper and the weight, the amount of ink transferred onto the non-image region is determined by organoleptic examination.

The evaluation criteria are the followings:

G0: No ink transfer.

G1: Slight ink transfer, but without practical problem.

G2: Some ink transfer, causing practical problems in use.

G3: Significant ink transfer.

### -Long-Term Storage Stability-

The long-term storage stability is evaluated as follows: The long-term storage stability is evaluated by storing an ink sample in a test environment for three years and comparing the ink viscosity and the ink surface tension before and after storage.

-Evaluation Criteria-

G1: Change in properties of less than 5% with respect to the initial values.

G2: Change in properties of 5% or more and less than 15% with respect to the initial values.

G3: Change in properties of 15% or more with respect to the initial values.

### -Optical Density-

The optical density of the printed region in a printed pattern is determined by using X-Rite 404 (manufactured by X-Rite). The evaluation criteria are as follows:

-Evaluation Criteria (Black Ink)-

G1: Optical density: 1.4 or more

G2: Optical density: 1.3 or more and less than 1.4

G3: Optical density: less than 1.3

-Evaluation Criteria (Color Ink)-

G1: Optical density: 1.1 or more

G2: Optical density: 1.0 or more and less than 1.1

G3: Optical density: less than 1.0

### -Curl and Cockle-

The curl and the cockle are evaluated as follows:

A recording medium carrying a 100%-coverage pattern is place on a flat plane, and the heights of the curl at the four corners are determined, and the average thereof was used as the indicator of the curl.

The evaluation criteria are as follows:

G0: Less than 5 mm

G1: 5 mm or more and less than 10 mm

G2: 10 or more and less than 20 mm

G3: 20 mm or more

As for the cockle, the height of the cockle generated on a recording medium carrying a 100%-coverage printed pattern immediately after printing is determined and used as the indicator of the cockle.

The evaluation criteria are as follows:

G1: Less than 1 mm

G2: 1 mm or more and less than 3 mm

G3: 3 mm or more

TABLE 1

| | | Colorant particle | | | | | | | Evaluation | | | | |
|---|---|---|---|---|---|---|---|---|---|---|---|---|---|
| | | | | | | Coating | | | | | Long- | | |
| | | | Core particle | | | layer | Adsorbed particle | | Fixing property | | term | | |
| | | mv | Tg | mn | | Thickness | mn | Coverage rate | Room | Heating | storage | Optical | Curl & |
| | | (nm) | (° C.) | (nm) | mw | (nm) | (nm) | (%) | temperature | (90° C.) | stability | density | cockle |
| Example 1 | Ink A | 200 | 71 | 100 | 28000 | 20 | — | — | G1 | G1 | G1 | G1 | G1 |
| | Coated colorant | | | | | | | | | | | | |
| | (colored) | | | | | | | | | | | | |
| Example 2 | Ink B | 250 | 20 | 150 | 21000 | 21 | — | — | G1 | G0 | G1 | G1 | G1 |
| | Coated colorant | | | | | | | | | | | | |
| | (colored) | | | | | | | | | | | | |
| Example 3 | Ink C | 230 | 55 | 120 | 15000 | 40 | — | — | G1 | G1 | G1 | G1 | G1 |
| | Coated colorant | | | | | | | | | | | | |
| | (colored) | | | | | | | | | | | | |
| Example 4 | Ink D | 330 | 45 | 150 | 14000 | 25 | — | — | G1 | G0 | G1 | G2 | G1 |
| | Coated colorant | | | | | | | | | | | | |
| | (colored) | | | | | | | | | | | | |
| Example 5 | Ink E | 250 | −6 | 200 | — | 25 | — | — | G0 | G0 | G1 | G2 | G1 |
| | Coated colorant | | | | | | | | | | | | |
| | (colored) | | | | | | | | | | | | |
| Example 6 | Ink F | 900 | 30 | 700 | 28000 | — | 16 | 83 | G1 | G0 | G1 | — | G1 |
| | Coated colorant | | | | | | | | | | | | |
| | (colored) | | | | | | | | | | | | |
| Comparative | Ink G | 95 | — | — | — | — | — | — | G3 | G3 | G1 | G1 | G1 |
| Example 1 | Pigment alone | | | | | | | | | | | | |
| | (colored) | | | | | | | | | | | | |
| Comparative | Ink H | 95 | — | — | — | — | — | — | G1 | G0 | G3 | G1 | G1 |
| Example 2 | Pigment alone | | | | | | | | | | | | |
| | (colored) | | | | | | | | | | | | |
| Comparative | Ink I | 400 | 82 | 100 | 80000 | 40 | — | — | G3 | G2 | G1 | G2 | G1 |
| Example 3 | Coated colorant | | | | | | | | | | | | |
| | (colored) | | | | | | | | | | | | |
| Example 7 | Ink J | 50 | 60 | 40 | — | — | 16 | 26 | G1 | G1 | G1 | — | G1 |
| | Adsorbed | | | | | | | | | | | | |
| | colorant | | | | | | | | | | | | |
| | (transparent) | | | | | | | | | | | | |
| Example 8 | Ink K | 200 | 45 | 150 | 14000 | 30 | — | — | G1 | G0 | G1 | G1 | G0 |
| | Adsorbed | | | | | | | | | | | | |
| | colorant | | | | | | | | | | | | |
| | (colored) | | | | | | | | | | | | |

As apparent from Table 1, the inks obtained in Examples are superior both in fixing property and long-term storage stability to those in Comparative Examples. They are also favorable in optical density. In addition, it is possible to reduce curl and cockle favorable by adding a compound having three or more hydroxyl groups to the ink.

The inks are ejected from a thermal recording head in the Examples above, and show favorably ejection property without nozzle clogging.

The foregoing description of the embodiments of the present invention has been provided for the purposes of illustration and description. It is intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An inkjet ink, comprising at least colorant particles, a water-soluble organic solvent, and water, each of the colorant particles comprising a core particle and a coating layer formed around the core particles and the core particle containing a resin material having a glass transition temperature (Tg) of 75° C. or lower.

2. The inkjet ink of claim 1, wherein the coating layer contains a pigment.

3. The inkjet ink of claim 1, wherein the coating layer contains a self-dispersible pigment.

4. The inkjet ink of claim 1, wherein the coating layer contains an inorganic oxide.

5. The inkjet ink of claim 1, wherein the thickness of the coating layer is 5 to 100 nm.

6. The inkjet ink of claim 1, wherein the weight-average molecular weight of the resin material of the core particle is 10,000 or more.

7. The inkjet ink of claim 1, wherein the number-average particle diameter of the core particles is 10 to 1,000 nm.

8. The inkjet ink of claim 1, further comprising a compound having three or more hydroxyl groups.

9. The inkjet ink of claim 8, wherein the compound having three or more hydroxyl groups is at least one compound selected from sugar compounds, glycerol, xylitol, pentaerythritol, and trimethylolpropane.

10. An inkjet ink, comprising at least colorant particles, a water-soluble organic solvent, and water, each of the colorant particles comprising a core particle and adsorbed particles on the surface thereof and the core particle containing a resin material having a glass transition temperature (Tg) of 75° C. or lower.

11. The inkjet ink of claim 10, wherein the adsorbed particle contains a pigment.

12. The inkjet ink of claim 10, wherein the adsorbed particle contains a self-dispersible pigment.

13. The inkjet ink of claim 10, wherein the adsorbed particle contains an inorganic oxide.

14. The inkjet ink of claim 10, wherein the number-average particle diameter of the adsorbed particles is 10 to 200 nm.

15. The inkjet ink of claim 10, wherein the weight-average molecular weight of the resin material of the core particle is 10,000 or more.

16. The inkjet ink of claim 10, wherein the number-average particle diameter of the core particles is 10 to 1,000 nm.

17. The inkjet ink of claim 10, further comprising a compound having three or more hydroxyl groups.

18. The inkjet ink of claim 17, wherein the compound having three or more hydroxyl groups is at least one compound selected from sugar compounds, glycerol, xylitol, pentaerythritol, and trimethylolpropane.

19. An inkjet ink set, comprising the inkjet ink of claim 1 and a processing solution containing at least a compound having an effect of aggregating or insolubilizing the ink components, a water-soluble solvent and water.

20. An inkjet ink set, comprising the inkjet ink of claim 10 and a processing solution containing at least a compound having an effect of aggregating or insolubilizing the ink components, a water-soluble solvent and water.

21. An inkjet ink tank, containing the inkjet ink of claim 1.

22. An inkjet ink tank, containing the inkjet ink of claim 10.

23. An inkjet-recording method of using the inkjet ink of claim 1, comprising
fixing an image formed by using the ink on a recording medium by heating the image.

24. An inkjet-recording method of using the inkjet ink of claim 10, comprising
fixing an image formed by using the ink on a recording medium by heating the image.

25. An inkjet-recording apparatus, comprising a recording head of ejecting the inkjet ink of claim 1.

26. The inkjet-recording apparatus of claim 25, further comprising a fixing unit that fixes an image formed by using the ink on a recording medium by heating the image.

27. An inkjet-recording apparatus, comprising a recording head of ejecting the inkjet ink of claim 10.

28. The inkjet-recording apparatus of claim 27, further comprising a fixing unit that fixes an image formed by using the ink on a recording medium by heating the image.
